(19) United States
(12) Patent Application Publication
(10) Pub. No.: US 2020/0167829 A1
(43) Pub. Date: May 28, 2020

(54) CUSTOMIZING ELECTRONIC COUPON SYSTEM & METHOD

(71) Applicant: Fund2Save, LLC, Fargo, ND (US)

(72) Inventors: Mark Larry Teckenburg, Fargo, ND (US); Michele Lori Stark, Bloomington, MN (US)

(21) Appl. No.: 16/714,226

(22) Filed: Dec. 13, 2019

Related U.S. Application Data
(63) Continuation of application No. 15/230,008, filed on Aug. 5, 2016, now abandoned.
(60) Provisional application No. 62/201,218, filed on Aug. 5, 2015.

(51) Int. Cl. G06Q 30/02

(52) U.S. Cl. CPC G06Q 30/0269; G06Q 30/0277; G06Q 30/0267

(57) ABSTRACT

A coupon system is disclosed that allows for the issuance of a personalized electronic coupon book. A user may communicate with the coupon system via a computer. Using this computer, the user may review a list of coupon sponsors on the coupon system, and may select a plurality of coupon sponsors for inclusion in the user's electronic coupon book.

### CROSS-REFERENCE TO RELATED APPLICATIONS

The present application is a continuation of U.S. Non-provisional application Ser. No. 15/230,008, filed Aug. 5, 2016, which claims the benefit of U.S. Provisional Application No. 62/201,218, filed Aug. 5, 2015, the content of which are hereby incorporated by reference in their entirety.

### FIELD

Disclosed herein is a system and methods to generate and utilize electronic coupon books, for instance to support the fundraising activities of local organizations of various types (e.g., youth-based).

### BACKGROUND

Electronic coupon books may be more efficient than the paper coupon books that youth organizations traditionally sell for fundraisers. With electronic coupons, the coupons may be more readily accessible (as mobile computing devices become more and more prevalent, and as an increasing percentage of the population typically carries around at least one mobile computing device for a significant amount of time each day), thereby eliminating the need to carry around a traditional paper coupon book. There are other issues associated with paper coupons. For example, paper coupons may be lost, may have a shortened expiration date (e.g., known paper coupon books do not have the expiration date of the individual paper coupons being based on when the user buys the paper coupon book), and they may have geographical restrictions. Electronic coupons provide for ease of use and combat many of the problems associated with paper coupons.

### SUMMARY

A coupon system and method are disclosed that allow for the issuance of a personalized electronic coupon book. A user may communicate with the coupon system via a computer. Using this computer, the user may review a list of coupon sponsors on the coupon system, and may select a plurality of coupon sponsors for inclusion in the user's electronic coupon book.

### BRIEF DESCRIPTION OF THE FIGURES

FIG. 1 is one embodiment of a couponing system that includes a coupon system and a plurality of users.

FIG. 2 is a schematic of one embodiment for the coupon system of FIG. 1.

FIG. 3 is one embodiment of a customized electronic coupon book database that may be used by the coupon system of FIGS. 1-2.

FIG. 4 is one embodiment of a sponsor database that may be used by the coupon system of FIGS. 1-2.

FIG. 5 is one embodiment of a sponsor region database that may be used by the coupon system of FIGS. 1-2.

FIG. 6A is one embodiment of a customized electronic coupon book generation or compilation protocol that may be used by the coupon system of FIGS. 1-2.

FIG. 6B is a representative home page that may be used for the coupon system of FIGS. 1-2.

FIG. 6C is a screen that may be displayed to a user of the coupon system of FIGS. 1-2 during execution of the customized electronic coupon book generation protocol of FIG. 6A.

FIG. 7A is one embodiment of an available coupon notification protocol that may be used by the coupon system of FIGS. 1-2.

FIG. 7B is a screen that may be displayed to a user of the coupon system of FIGS. 1-2 during execution of the available coupon notification protocol of FIG. 7A.

FIG. 8 is one embodiment of an out-of-area coupon notification protocol that may be used by the coupon system of FIGS. 1-2.

FIG. 9 is one embodiment of an expiring coupon notification protocol that may be used by the coupon system of FIGS. 1-2.

FIG. 10A is one embodiment of a customized electronic coupon book viewing protocol that may be used by the coupon system of FIGS. 1-2.

FIG. 10B is a screen that may be displayed to a user of the coupon system of FIGS. 1-2 during execution of the customized electronic coupon book viewing protocol of FIG. 10A.

### DETAILED DESCRIPTION

An electronic coupon system and related methods are disclosed herein. It should be appreciated that each method to be described herein is intended to be covered, as well as a coupon system that implements one or more of these individual methods. Generally, electronic coupon books may facilitate higher satisfaction between a given fundraising organization and the purchaser of such an electronic coupon book (or other user of the electronic coupon book). This may be furthered by the additional ability to customize an electronic coupon book in the manner to be described herein. That is, customized electronic coupon books may be generated by users, therefore allowing for a more personalized electronic coupon book and potentially less unwanted coupons that may go unused. This may allow for a greater sense of value about the user's support of a particular organization through purchase of an electronic coupon book. As such, the system and methods addressed herein should assist with fundraising efforts by organizations by allowing for generation of a customized electronic coupon book for each person that chooses to financially support a particular organization through purchase of such an electronic coupon book.

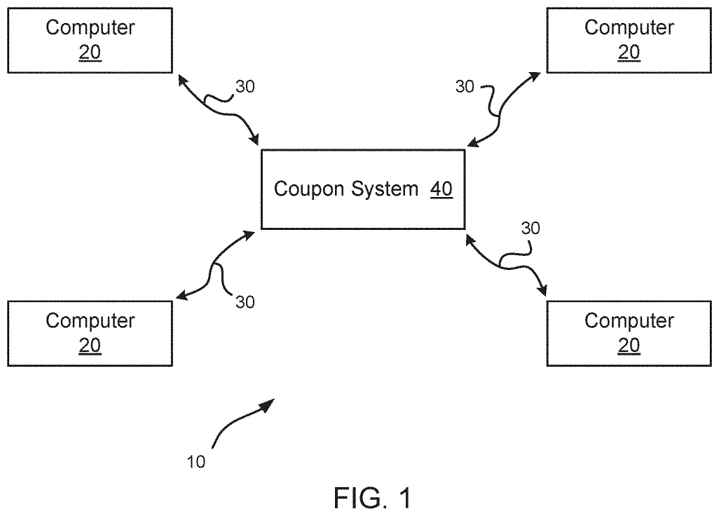

A personalized electronic coupon book may be generated using the couponing system 10 shown in FIG. 1. As used herein, a “user” in an individual that has purchased an electronic coupon book through the couponing systems 10. “Sponsors” or “vendors” are entities that provide goods or services, and that offer coupons through the couponing system 10. The couponing system 10 includes a coupon system 40. The coupon system 40 stores electronic coupons and customized electronic books that have been created by users, allows users to create and access their customized electronic coupon books, and may provide various notification functions to enhance the use of customized electronic coupon books that are stored on the coupon system 40. As such, users of the coupon system 40 are not required to store their customized electronic coupon book(s) locally in any respect.

A given user may interface or interact with the coupon system 40 using a computer 20 (including a mobile computing device) that communicates with the coupon system 40 over a network 30 or other appropriate communication link. Any appropriate number of computers 20 may communicate with the coupon system 40 over one or more networks 30. Each computer 20 may be of any appropriate type, such as a desktop, a laptop, a tablet, a smart phone, a personal digital assistant, or the like. The network 30 generally allows each individual computer 20 to communicate with the coupon system 40, and may be in the form of the Internet, a wireless network, a public network, or the like.

The coupon system 40 may utilize a mobile website, or an app that is stored on an individual computer 20, to facilitate communications between the coupon system 40 and the individual users via a computer 20. Any appropriate architecture may be used for the couponing system 10, including a client-server architecture (where the coupon system 40 would correspond with the “server,” and where the “client” would correspond with the various individual computers 20 (users).

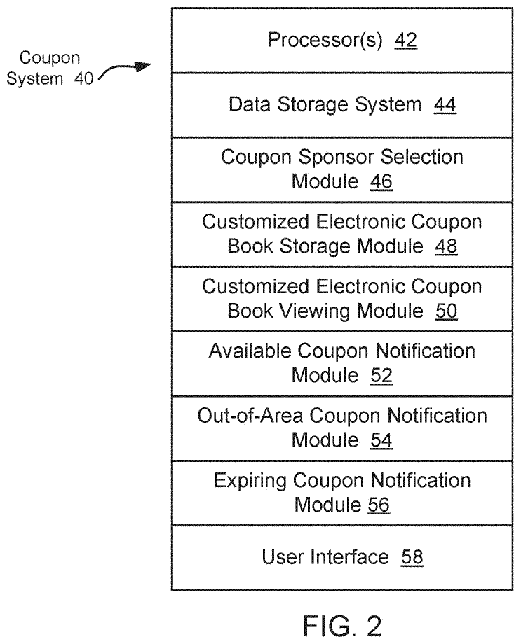

One embodiment of the coupon system 40 is presented in FIG. 2. The coupon system 40 may incorporate one or more servers, a website, or both. In any case, the coupon system 40 may utilize one or more processors 42, a data storage system 44 (e.g., incorporated/embodied by a non-transitory computer-readable storage medium), a coupon sponsor selection module 46 (e.g., for compiling or generating a customized electronic coupon book), a customized electronic coupon book storage module 48, a customized electronic coupon book viewing module 50, an available coupon notification module 52, an out-of-area coupon notification module 54, an expiring coupon notification module 56, and an appropriate user interface 58. The configuration of each of these modules 46, 48, 50, 42, and 54, as well as any protocols that may be used by each of these modules and as described herein, may be incorporated/embodied by a non-transitory computer-readable storage medium (e.g., each such module and each such protocol may be of a non-transitory form).

The coupon selection module 46 may be configured to assist a user (through a computer 20) in creating a customized electronic coupon book on the coupon system 40, and which may be stored by the coupon system 40 using the data storage system 44 and/or the customized electronic coupon book storage module 48. A user (through a computer 20) may view his/her customized electronic coupon book (stored on the data storage system 44 of the coupon system 40, and including one or more associated coupons) using the customized electronic coupon book viewing module 50.

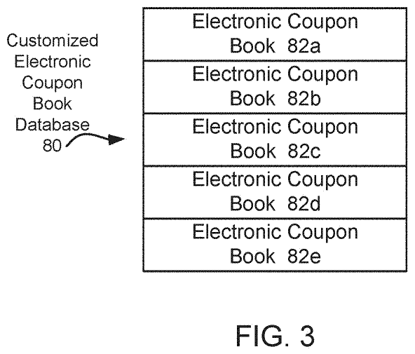

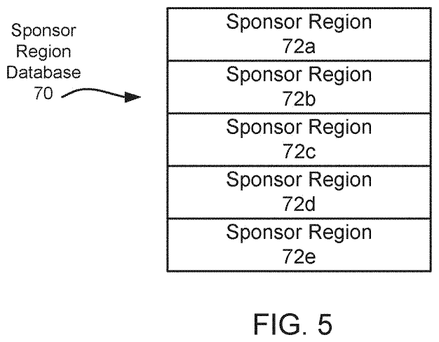

The coupon system 40 will typically store a plurality of customized electronic coupon books for a plurality of different users. The couponing system 10 alleviates the need for a user to store an electronic coupon book locally on one or more computers 20 (including on a mobile computing device for the user, such as a tablet or smart phone). In this regard, the data storage system 44 of the coupon system 40 may include a customized electronic coupon book database 80 (FIG. 3) in which a plurality of customized electronic coupon books 82 may be stored (customized electronic coupon books 82a-82e being shown in FIG. 5 for illustrative purposes only). Any way of storing customized electronic coupon books 82 on the coupon system 40 may be utilized.

A given user of the couponing system 10 may have any appropriate number of customized electronic coupon books 82 stored on the coupon system 40 (e.g., within the electronic coupon book database 80). That is, to further customize a user's electronic coupon books 82, the user of the couponing system 10 may in fact create multiple customized coupon books 82 and store them in the customized electronic coupon book storage module 48 of the coupon system 40 for later access. For instance, when a user of the couponing system 10 is routinely in different sponsor regions 72, the user may generate a customized coupon book 82 that is specific to each sponsor region 72. In any case, each such customized electronic coupon book 82 may be available to the user through the couponing system 10. Each individual electronic coupon book 82 may be viewed by the corresponding user using the customized electronic coupon book viewing module 50 of the coupon system 40, where a user may select which coupon book 82 they want to use at a given time. All of this information from the user's account, where they create one or more electronic coupon books 82, may be stored in the data storage system 44 of the coupon system 40.

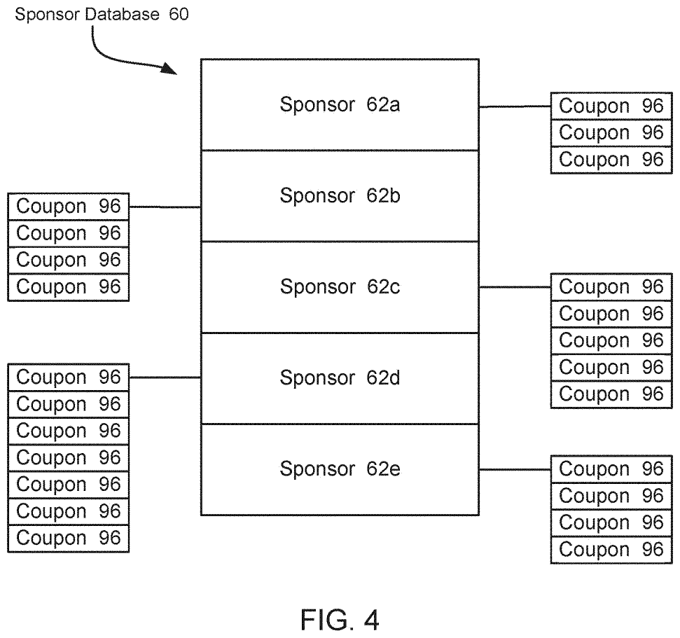

A given electronic coupon book 82 will typically include electronic coupons from a number of different sponsors or vendors. In this regard, the data storage system 44 of the coupon system 40 may include what may be characterized as a sponsor database 60 (FIG. 4), which in turn may include any appropriate number of sponsors 62 (sponsors 62a-62e being shown in FIG. 4 for illustrative purposes only). One or more coupons 96 may be associated with a given sponsor 62 in the sponsor database 60 for the coupon system 40. Any appropriate number of coupons 96 may be associated with each sponsor 62. Sponsors 62/coupons 96 that are affiliated with the coupon system 40 may be stored in any appropriate manner by the coupon system 40. One embodiment has the coupon system 40 being configured such that selecting a particular sponsor 62 for their respective electronic coupon book 82 in turn selects all coupons 96 that are on the coupon system 40 for that particular sponsor 62 (e.g., at least in a certain geographical area). Another embodiment has the coupon system 40 being configured such that a user may individually select one or more coupons 96 from a given sponsor 62. In any case, the phrase “selecting a sponsor 62” may be equated with “selecting at least one coupon 96 from such a sponsor 62.”

Electronic coupon books 82 that are stored on the coupon system 40 may be local or regional in relation to the sponsors 62. That is, each of the sponsors 62 within a given electronic coupon book 82 may be from a common area or region. Such a common area or region may be defined in any appropriate manner. The coupon system 40 may service any number of areas or regions throughout a larger territory (e.g., the coupon system 40 may be configured to provide electronic coupon books on a state-by-state basis, on a county-by-county basis, on a metro area-by-metro area basis, or any appropriate geographical basis). As such, the coupon system 40 may utilize what may be referred to as a sponsor region database 70 having one or more sponsor regions 72 (sponsor regions 72a-72e being shown in FIG. 5 for illustrative purposes only). Each sponsor region 72 in the sponsor region database 70 could link to the associated sponsors 62 (including their corresponding electronic coupons 96) in the sponsor database 60 (i.e., sponsors 62 that are in the geographical area encompassed by the particular sponsor region 72). Alternatively, each sponsor region 72 in the sponsor region database 70 may not only be associated with a particular geographical area, but it may also list all sponsors 62 for that particular area (including their corresponding electronic coupons 96).

One or more notification modules of the coupon system 40 of FIG. 2 may be used to send coupon-related notifications to a user of the couponing system 10, more specifically to one or more computers 20 that have been associated with the user in the coupon system 40. The coupon system 40 may be configured to send a notification to a user (via an associated computer 20) when the user is in proximity to a sponsor/vendor 62 for which the user has at least one electronic coupon 96 stored in their respective customized electronic coupon book 82 (via the available coupon notification module 52 of the coupon system 40). That is, the available coupon notification module 52 functions to alert the user of coupons 96 (from a corresponding electronic coupon book 82) that may be available for use/redemption based upon the current location of the user (more specifically the current location of a computer 20 that is associated with the user in the coupon system 40). This alert may occur at various times and by various means. One way to alert the user may be through push notifications from the coupon system 40 (e.g., where the coupon system 40 is able to acquire location information on a particular user). These push notifications may be in the form of texts, emails, pop-up windows, etc. A push notification includes when the coupon system 40 sends a signal to the user's computer 20 after ascertaining that the computer 20 may be in proximity to a sponsor 62 in their corresponding electronic coupon book 82. Such a signal may embody information regarding which coupons 96 may be available for the user to redeem in their current locale (again, more specifically the locale of a computer 20 that is associated with the user in the coupon system 40).

The coupon system 40 of FIG. 2 may be configured to send a notification to a user (via a computer 20 that is associated with the user in the coupon system 40) when the user is outside of a region that is associated with the user's electronic coupon book 82 (stored on the coupon system 40), for instance when the user is traveling, namely in instances where the coupon system 40 offers electronic coupons 96 in this other region (all via the out-of-area coupon notification module 54 of the coupon system 40). That is, each electronic coupon book 82 that is stored by the coupon system 40 may be associated with a particular region. When the user associated with a particular electronic coupon book 82 is outside of the region associated with this particular electronic coupon book 82 (more specifically a computer 20 that is associated with this user in the coupon system 40), the coupon system 40 may send a notification to the user if electronic coupons 96 are available from the coupon system 40 for this other region.

The coupon system 40 may be configured to send a notification to a user (via a computer 20 that is associated with the user in the coupon system 40) when one or more electronic coupons 96 in the user's electronic coupon book 82 (stored on the coupon system 40) is going to expire within a certain upcoming time period (all via the expiring coupon notification module 56 of the coupon system 40). Within each electronic coupon book 82 stored on the coupon system 40, there may be a variety of different electronic coupons 96, and each electronic coupon 96 may have an associated expiration date (although one or more electronic coupons 96 in a given electronic coupon book 82, including all electronic coupons 96 in such an electronic coupon book 82, could have a common expiration date). One problem with the paper coupon books is that the user has to diligently check for any expiring paper coupons (by a manual review of the paper coupon book). This task may be viewed as burdensome and time consuming by at least some people, and oftentimes leads to users wasting coupons because they are not aware of when they expire. The expiring coupon notification module 56 of the coupon system 40 of FIG. 2 remedies this problem by sending a push notification to the user pertaining to what electronic coupons 96 within their electronic coupon book(s) 82 may be set to expire within a given time span. This notification may prompt the user to redeem the electronic coupon 96, thereby giving the user a greater appreciation for the electronic customized coupon books 82 addressed herein (over paper coupon books). The notification may be pushed in a similar manner as the previous notification modules. This notification module 56 may be set to send out the notification at a specified time (e.g., a few days, a week, a month, etc.) from the expiration date of the relevant electronic coupon 96. With the user being more informed about the electronic coupons 96 in their corresponding electronic coupon book(s) 82 that are about to be expire, the user may feel more inclined to donate money for an electric coupon book 82 versus paper coupon books.

A communication link between the coupon system 40 and a user (through a computer 20) is required for the user to utilize the functionality of the coupon system 40. A user may log into or “launch” the coupon system 40 over the network 30 in any appropriate manner (e.g., through a locate website or app that has been previously downloaded (or otherwise stored) on a computer 20 for the user). This may be undertaken though/using the user interface 58 of the coupon system 40 (FIG. 2). In any case and once the user gains access to the coupon system 40, the user may begin creating a customized electronic coupon book 82 by identifying or selecting a particular fundraising organization to be supported by the purchase of a customized electronic coupon book 82 (e.g., youth sport organizations, youth activity organizations, non-profit organizations). Revenues that are generated by the compilation of a customized electronic coupon book 82 through the couponing system 10 may be split between the operator of the coupon system 40 and the designated fundraising organization on any appropriate basis. Other business models may implement the couponing system 10 described herein.

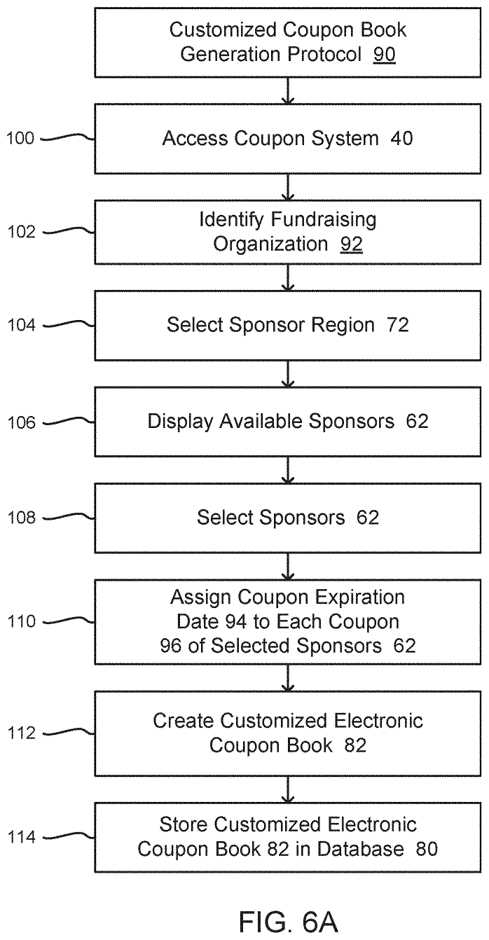

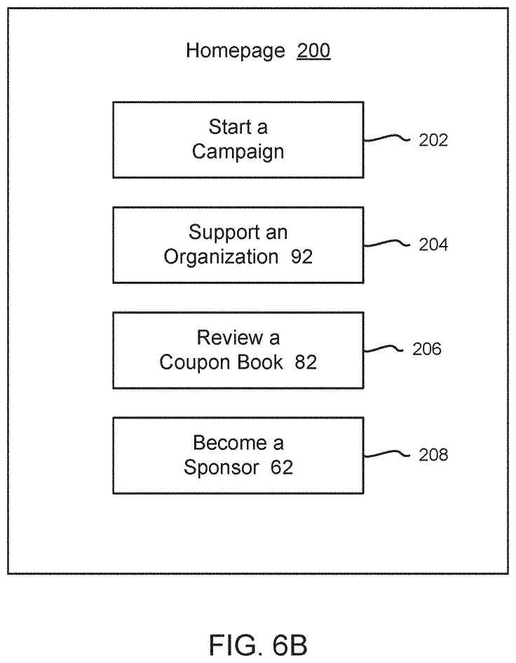

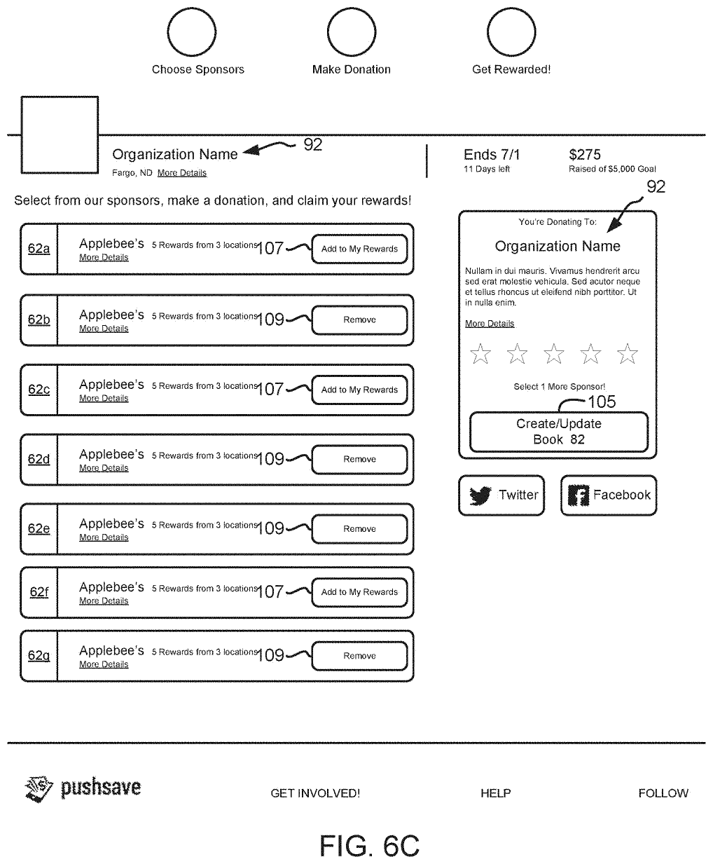

One function of the coupon system 40 is to allow a user to compile or generate a customized electronic coupon book 82. One embodiment of a protocol for providing this functionality is illustrated in FIG. 6A, is identified by reference numeral 90, and may be used by the coupon sponsor selection module 46 of the coupon system 40. The customized coupon book generation protocol 90 includes a step 100, where the user accesses the coupon system 40. Access may be granted through the action of logging in through the user interface 58 to view the user account that contains the information specific to that user, and which may include one or more associated customized electronic coupon books 82. Step 102 may be the identification of the fundraising organization 92 (to the coupon system 40) in which the user desires to support through donations (e.g., “donations” being through purchase of an electronic coupon book 82). After a selection or identification of a particular fundraising organization 92, the user may begin the actual process of creating a customized electronic coupon book 82.

The customized electronic coupon book generation protocol 90 may be configured to prompt or require the user to input or select a sponsor region 72 (e.g., from the sponsor region database 70 of FIG. 5). This may be done through execution of step 104 of the protocol 90. The protocol 90 may be configured to present a default sponsor region 72 based upon the location of the fundraising organization 92 from step 102 (e.g., the default sponsor region 72 may be a geographical region that includes the location of the fundraising organization 92). The protocol 90 may be configured to provide the user with the ability to manually change the sponsor region 72 (e.g., via step 104). For example, a relative living in one state may wish to donate to a fundraising organization 92 that may be located in a different state (e.g., a grandchild living in another state), but still wish to receive coupons 96 for the state in which the relative resides. This would be an example of manually selecting the region 72 to correspond to a customized coupon book 82.

A user of the couponing system 10 (through a computer 20 in communication with the coupon system 40) may use the coupon sponsor selection module 46 (FIG. 2) to pick a desired sponsor 62 from a plurality of coupon sponsors 62. The customized coupon book generation protocol 90 of FIG. 6A may be configured to display a listing of available sponsors 62 (step 106). Again, sponsors 62 may be filtered based on their geographical region 72 so as to allow for more efficient coupon customization by a user (step 104). That is, when selecting a specific sponsor region 72 (step 104), the user may be presented with a list of sponsor regions 72. This list may utilize the sponsor region database 70 discussed above in relation to FIG. 5. Compiled in this database 70 may be all of the participating sponsor regions 72 from which sponsors 62 are located and that is served by the coupon system 40. The sponsor regions 72 may be geographically determined regions 72 that may be predetermined based on an area such as a state, a county, or any other boundary specific area proximal to the user's computer 20. The sponsor regions 72 may be listed alphabetically, by state, by most sponsor-populated areas, or by any other means of classification.

Selection of a sponsor region 72 (step 104 of the protocol 90) may cause the sponsors 62 for the selected sponsor region 72 to be displayed (step 106 of the protocol 90). Sponsors 62 for selection by a user of the coupon system 40 may be presented in any appropriate way. One or more sponsors 62 may be selected by the user in any appropriate manner pursuant to step 108 of the protocol 90. Once a given sponsor 62 has been selected by the user, that sponsor 62 may be removed from the list of available sponsors 62 (step 106) so as to prevent the user from wasting time by selecting the same sponsor 62 multiple times. In any case, the user may continue to select sponsors 62 through execution of step 108 until their customized electronic coupon book 82 has been completed to their satisfaction.

The customized electronic coupon book generation protocol 90 of FIG. 6A may include the ability to assign “customized” expiration dates for a particular electronic coupon book 82. In this regard, coupons 96 associated with selected sponsors 62 (step 108) may be assigned a coupon expiration date 94 that is based upon the date that the electronic coupon book 82 is created or compiled through the protocol 90. This assigning of a coupon expiration date 94 may occur almost simultaneously with the selection of the sponsor 62, which solves the problem that the paper coupon books have with expiration dates being shortened due to a non-customizable date (i.e., with a paper coupon book, an individual that purchases the paper coupon book at the end of the fundraising will have less time to use the coupons than an individual that purchased the paper coupon book at the start of the fundraising).

After all of the desired sponsors 62 have been selected (step 108), a customized electronic coupon book 82 may be created pursuant to step 112 of the customized coupon book generation protocol 90. This customized electronic coupon book 82 may be stored in the customized electronic coupon book database 80 (FIG. 3), and in any case is electronically accessible by the associated user through the coupon system 40.

FIG. 6B presents a representative embodiment of a home page 200 that may be used by the coupon system 40. Any number/selection of functions may be associated with the home page 200. Four functions are illustrated in conjunction with the home page 200. Other functions could be accessed through the home page 200, and/or different combinations of functions could be accessed through the home page 200 (e.g., the “review a coupon book 82” function need not be included on the home page 200). One function is to start a campaign, which may be accessed through button 202 on the home page 200, and which may be utilized by a fundraising organization 92 to start/manage a fundraising campaign that is based upon the sale of electronic coupon books 82 as described herein. Another function is to support an organization 92, which may be accessed through button 204 on the home page 200, and which may be utilized by a user that has elected to purchase one or more electronic coupon books 82 to support a particular organization 92. Another function is to provide the ability for a user of the coupon system 40 to review his/her electronic coupon book(s) 82 that are stored by the coupon system 40, and which may be accessed through button 206 on the home page 200. Another function is provide the ability for sponsors 62 to participate in the coupon system 40 by making one or more coupons 96 available for inclusion in electronic coupon books 82, and which may be accessed through button 208 on the home page 200.

FIG. 6C presents a representative output from the user interface 58 of the coupon system 40, and which may be viewed by a user of the couponing system 10 through a computer 20. For instance, FIG. 6C may be presented to a user when creating a customized electronic coupon book 82 through execution of the protocol 90 of FIG. 6A (e.g., in response to activation of the support an organization 92 button 204 on the home page 200 of FIG. 6B). After a user has gained access to the coupon system 40, the screen or page shown in FIG. 6C (or one similar thereto) may be presented to the user after the user has selected a fundraising organization 92 (step 102 of the protocol 90 of FIG. 6A). The identity of the fundraising organization 92 (to which a customized electronic coupon book 82 will be assigned) may be presented at one or more locations on the screen.

Activating the support an organization 92 button 204 on the home page 200 (FIG. 6B) may access the coupon sponsor selection module 46 (FIG. 2) to start an electronic coupon book 82. More specifically, this may retrieve sponsors 62 from the sponsor database 60 of the coupon system 40, and which may be displayed to the user on the screen of FIG. 6C. The screen may include the ability to scroll or otherwise navigate through a list of sponsors 62. Various sponsor information may be displayed to the user, including the identity of the sponsor 62, the number of locations for this sponsor 62, the number of coupons available from this sponsor 62, and the like. The ability to obtain additional details on each such sponsor 62 may be presented on the screen of FIG. 6C as well.

A button may be presented adjacent to each sponsor 62 being presented on the screen of FIG. 6C. This button may be in the form of an add sponsor button 107 (to add the sponsor 62 and associated coupons 96 to the user's customized electronic coupon book 82). This button may also be in the form of a remove sponsor button 109 (to remove the sponsor 62 and associated coupons 96 from the user's customized electronic coupon book 82). Once the user has selected all of the desired sponsors 62, the user may activate a button 105 on the screen of FIG. 6C to create and store an electronic coupon book 82 on the coupon system 40 (e.g., within the customized electronic coupon book database 80 of FIG. 3). The price paid by the user for the customized electronic coupon book 82 may be based at least in part on the number of sponsors 62/coupons 96 have were selected.

The screen presented in FIG. 6C (or one similar thereto) may also be used by a user of the couponing system 10 to view view/manage a previously created and customized electronic coupon book 82. This may be accessed through activation of the button 206 on the home page 200 (FIG. 6B). Alternatively, the button 206 could be removed from the home page 200 of FIG. 6B, and activation of the button 204 on the home page 200 could be used to both create a new electronic coupon book 82 and to access a previously created electronic coupon book 82 that is now stored by the coupon system 40. In any case, the screen of FIG. 6C (or one similar thereto) may be used to add sponsors 62 to a previously created electronic coupon book 82, to remove sponsors 62 from a previously created electronic coupon book 82, and the like at least generally in the above-described manner. After any updating of the sponsors 62/coupons 96, the button 105 on FIG. 6C can be used to save the updated electronic coupon book 82 on the coupon system 40.

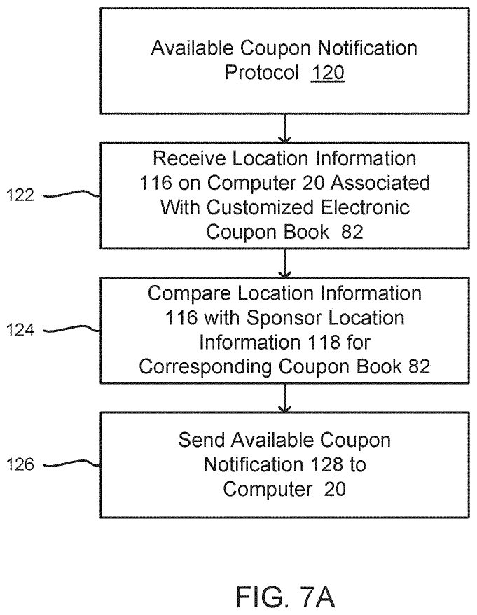

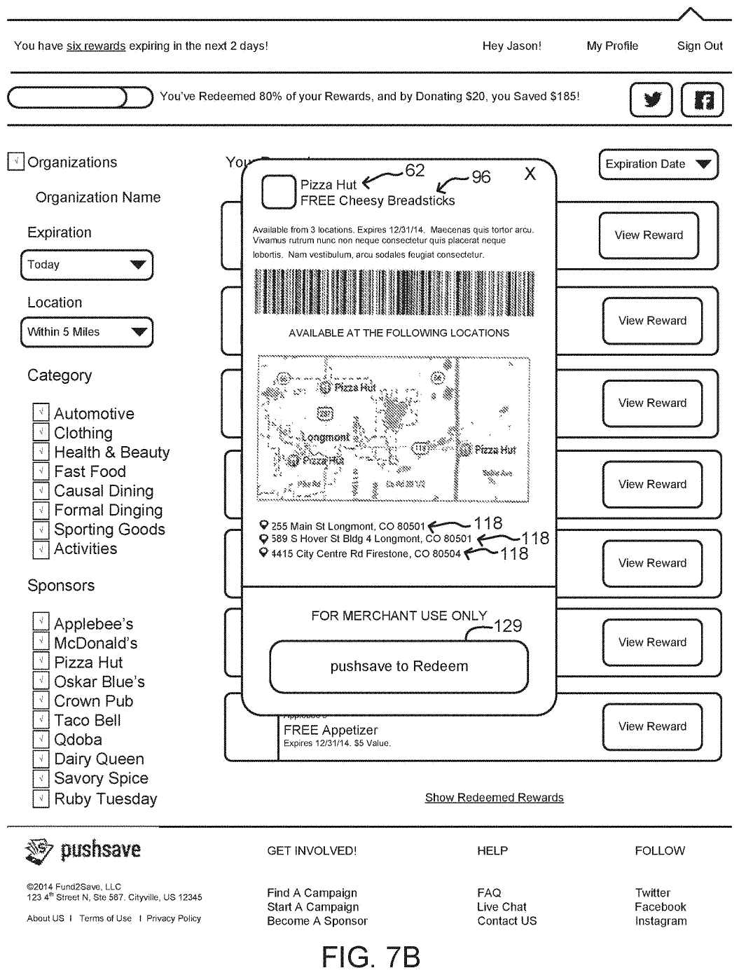

The coupon system 40 includes a number of features to facilitate use of coupons 96, and including use of a customized electronic coupon book 82 stored on the coupon system 40. One embodiment of an available coupon notification protocol is illustrated in FIG. 7A, is identified by reference numeral 120, and may be utilized by the available coupon notification module 52 of the coupon system 40 (FIG. 2). The coupon system 40 may be configured to allow a user to selectively activate the functionality associated with the available coupon notification protocol 120 of FIG. 7A, to selectively deactivate the functionality associated with the available coupon notification protocol 120, or both. Alternatively, the coupon system 40 may be configured to always execute the available coupon notification protocol 120.

Location information 116 on a computer 20 associated with a customized electronic coupon book 82 is received by the coupon system 40 pursuant to step 122 of the protocol 120. The coupon system 40 may locate the computer 20 through the use of a GPS location of the computer 20 (and with the coupon system 40 knowing an identification number or code of this computer 20). The coupon system 40 may acquire location information 116 on a computer 20 in any appropriate manner for purposes of step 122 of the protocol 120.

The location information 116 of a computer 20 may be compared with sponsor location information 118 for the corresponding electronic coupon book 82 (more specifically, the particular electronic coupon book 82 that is associated with the computer 20 on which location information 116 was acquired pursuant to step 122 of the protocol 120). The coupon system 40 compares which sponsors 62, from the sponsors 62 of the corresponding electronic coupon book 82, are at least in the same general location as the computer 20 (e.g., sponsors 62 within a predetermined distance (specified in the coupon system 40) of the current location of the computer 20). If the coupon system 40 determines that one or more sponsors 62 in a relevant electronic coupon book 82 are at least the same general location as an associated computer 20 (e.g., a computer 20 assigned to this electronic coupon book 82 in the coupon system 40), the coupon system 40 sends an available coupon notification 128 to the computer 20. Such an available coupon notification 128 may be of an appropriate type (e.g., a text, an email, a pop-up window, etc.), so long as the available coupon notification 128 alerts the corresponding user as to the existence of a “nearby” sponsor(s) 62/coupon(s) 96.

A depiction of an available coupon 96 that may be presented to a user of the coupon system 40 via the user interface 58 is illustrated by FIG. 7B. An available coupon notification 128 (FIG. 7A) may be presented in a similar manner as seen in this figure. The available coupon notification 128 may present a list of available coupons 96, and when one of the coupons 96 is selected, then the user may be presented with a pop-up, like the one illustrated in FIG. 7B and which may present information that is specific to that particular coupon 96. It may include the name of the sponsor 62, a description of the coupon 96, locations 118 in which this coupon 96 may be redeemed, and a redeem button 129 that allows the user to use the coupon 96 and receive the discount from the associated sponsor 62. This screen may also give the user a map to the location 118 in which the electronic coupon 96 may be redeemed.

An electronic coupon 96 from a user's electronic coupon book 82 may be presented to the associated sponsor 62 in order to be redeemed for a discount on merchandise, services, or the like. For instance and with regard to the screen display of FIG. 7B, the user may show that image to the sponsor 62. The sponsor 62 may then apply the coupon 96 to the purchase of goods, services, or the like. For instance, the sponsor 62 may verify the validity of the electronic coupon 96 and then may activate the redeem button 129 on the user's computer 20. Whether this is done by the user or the sponsor 62, activation of the redeem button 129 eliminates the coupon 96 from the corresponding electronic coupon book 82 such that this particular coupon 96 may no longer be used (or if the coupon 96 is reusable a number of times, activating the redeem button 129 provides for a reduction of the number of remaining usages of the electronic coupon 96). It should be noted that activating the redeem button 129 to use an electronic coupon 96 from a user's electronic coupon book 82 on the coupon system 40 does not cause the coupon system 40 (nor a computer 20 of the couponing system 10) to communicate in any respect with any type of computer system for the associated sponsor 62.

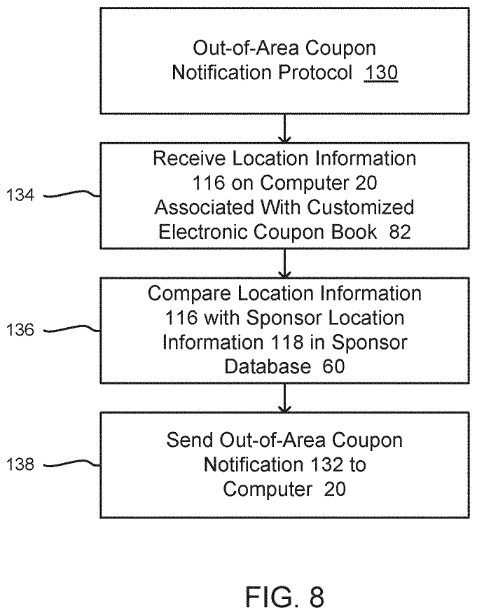

The coupon system 40 may be configured to communicate with a user of the couponing system 10 with regard to acquiring additional coupons 96. For instance, a user having an electronic coupon book 82 stored on the coupon system 40 (again where this electronic coupon book 82 is specific to a certain sponsor region 72) may be physically outside of the sponsor region 72 that is associated with the user's electronic coupon book(s) 82. However, the coupon system 40 may in fact have one or more coupons 96 that are available for use in the current location of the user. One embodiment of an out-of-area notification protocol is illustrated in FIG. 8, is identified by reference numeral 130, and may be utilized by the out-of-area coupon notification module 54 of the coupon system 40 (FIG. 2). The coupon system 40 may be configured to allow a user to selectively activate the functionality associated with the out-of area coupon notification protocol 130, to selectively deactivate the functionality associated with the out-of area coupon notification protocol 130, or both. Alternatively, the coupon system 40 may be configured to always execute the out-of area coupon notification protocol 130.

Location information 116 on a computer 20 associated with a customized electronic coupon book 82 is received by the coupon system 40 pursuant to step 134 of the protocol 130. Location information on a user/computer 20 for purposes of the out-of-area coupon notification protocol 130 may be in accordance with step 122 of the available coupon notification protocol 120 of FIG. 7A. In any case, the location information 116 of a computer 20 may be compared with sponsor location information 118 that is stored on the coupon system 40 (e.g., the sponsor database 60 of FIG. 4) pursuant to step 136 of the protocol 130. The coupon system 40 compares which of its sponsors 62 (stored on the coupon system 40) are at least in the same general location as the computer 20 (e.g., sponsors 62 within a predetermined distance (specified in the coupon system 40) of the current location of the computer 20). Step 136 may cause the coupon system 40 to initiate a comparison of location information 116 on the user/computer 20 with sponsor location information 118 in the sponsor database 60 (FIG. 4). For instance, the coupon system 40 may identify a sponsor region 72 associated with the current location of the user/computer 20 to identify sponsors 62 that may be in proximity to the current location of the user/computer 20.

If the coupon system 40 determines that one or more sponsors 62 are at least at the same general location as an associated computer 20 (step 136 of the out-of-area coupon notification protocol 130), the coupon system 40 sends an out-of-area coupon notification 132 to the computer 20 pursuant to step 138 of the protocol 130. Such an out-of-area coupon notification 132 may be of an appropriate type (e.g., a text, an email, a pop-up window, etc.), so long as the out-of-area coupon notification 132 alerts the corresponding user as to the existence of a “nearby” sponsor(s) 62/coupon(s) 96. The user may then have the option to add one or more sponsors 62/coupons 96 to their corresponding electronic coupon book 82 (e.g., through purchase) for use in accordance with the foregoing.

Global positioning system (GPS) capabilities implemented in the computer 20 may allow the coupon system 40 to pinpoint what sponsor region 72 the user and computer 20 may be in at a given time in the execution of the out-of-area coupon notification protocol 130 of FIG. 8. The coupon system 40 may be configured to know when a computer 20 may not be within the sponsor region 72 for the associated electronic coupon book 82 and/or to ascertain the particular sponsor region 72 in which the user/computer 20 are currently located. Once this new sponsor region 72 is identified to the coupon system 40, the coupon system 40 may begin to search for coupons 96 specific to this new sponsor region 72 for purposes of the out-of-area coupon notification protocol 130 of FIG. 8. The coupon system 40 may begin this search when the computer 20 is within a specified radius or distance (e.g., 5 miles, 50 yards, 100 feet, etc.) of a sponsor 62 within this new sponsor region 72. The coupons 96 that are identified for this new sponsor region 72 may be required to be of a similar type or category (e.g., restaurant, retailer, etc.) to the coupons 96 that are already generated and in the user's customized electronic coupon book 82 in order to generate an out-of-area coupon notification 132.

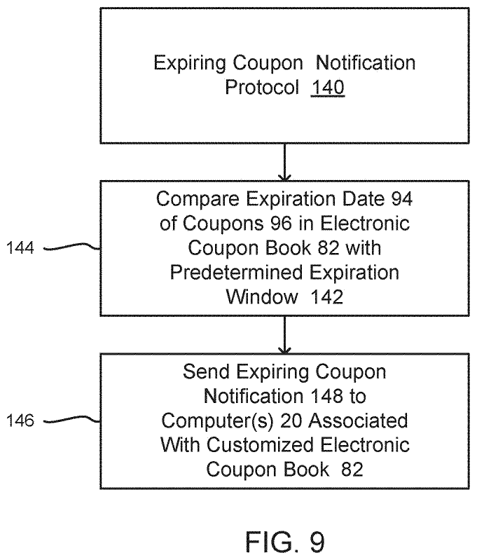

The coupon system 40 may be configured to communicate with a user of the couponing system 10 with regard to upcoming expiration of coupons 96 within the user's electronic coupon book(s) 82. One embodiment of an expiring coupon notification protocol is illustrated in FIG. 9, is identified by reference numeral 140, and may be utilized by the expiring coupon notification module 56 of the coupon system 40 (FIG. 2). The coupon system 40 may be configured to allow a user to selectively activate the functionality associated with the expiring coupon notification protocol 140, to selectively deactivate the functionality associated with the expiring coupon notification protocol 140, or both. Alternatively, the coupon system 40 may be configured to always execute the expiring coupon notification protocol 140.

The coupon system 40 may compare the expiration date 94 of a coupon 96 in a customized electronic coupon book 82 with a predetermined expiration window 142 (step 144). As addressed above, the expiration date 94 for coupons 96 in an electronic coupon book 82 may be set based upon the date that the coupon book 82 was generated and stored on the coupon system 40. The predetermined expiration window 142 (step 144) may be a predetermined time period of when a coupon 96 may be expiring. For example, the coupon system 40 may be configured to identify all coupons 96 that are expiring within the time period of the next two weeks, where this two-week span may be one option for the expiration window 142. All coupons 96 within a given electronic coupon book 82 may have their expiration dates 94 evaluated by the coupon system 40 to determine if they may be set to expire within that two-week span. The coupon system 40 could be configured with a default expiration window 142 and which could be modified by a user of the couponing system 10. The coupon system 40 could also be configured to allow the user to initially specify the expiration window 142 that is to be used by the expiring coupon notification protocol 140.

Once all upcoming expirations of coupons 96 within a given electronic coupon book 82 are identified by the coupon system 40 (step 144 of the expiring coupon notification protocol 140), the coupon system 40 may send an expiring coupon notification 148 to one or more computers 20 associated with the customized coupon book 82. Such an expiring coupon notification 144 may be of an appropriate type (e.g., a text, an email, a pop-up window, etc.), so long as the expiring coupon notification 148 alerts the corresponding user as to the upcoming expiration of one or more coupons 96. For instance, when a coupon 96 is determined by the coupon system 40 to have an expiration date 94 that is within the expiration window 142 (step 144), the coupon system 40 may notify the user by sending out an expiring coupon notification 148. An expiring coupon notification 148 may appear as a text that reads: “Coupon for Sponsor 62a will expire in 14 days.” Like previous notifications described herein, this one may also be a push notification to the user.

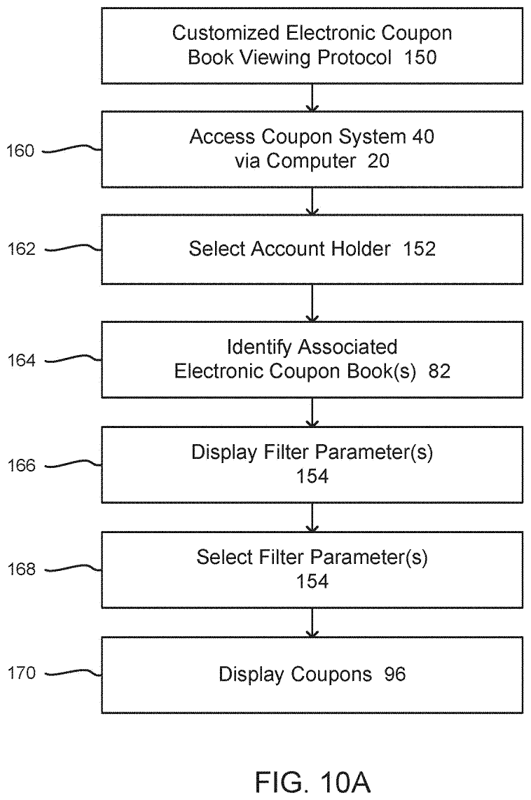

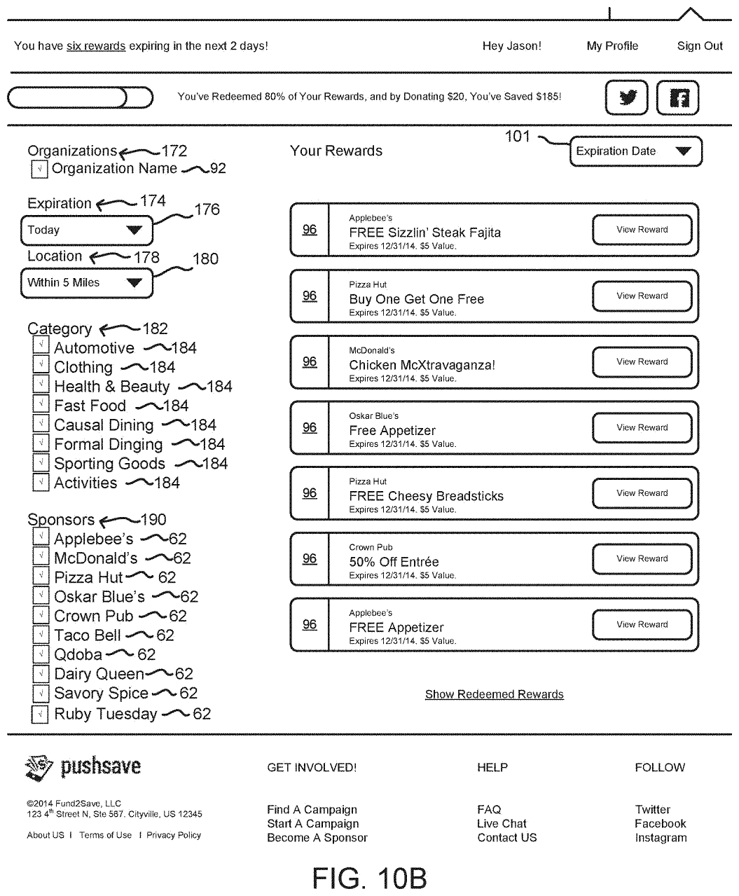

A number of “push communications” have been described in relation to the coupon system 40—where the coupon system 40 initiates contact with a user/computer 20 of the couponing system 10. However, a user of the couponing system 10 may also initiate communications with the coupon system 40 through a computer 20. One embodiment of a customized electronic coupon book viewing protocol is illustrated in FIG. 10A, is identified by reference numeral 150, and may be utilized by the customized electronic coupon book viewing module 50 of the coupon system 40 (FIG. 2).

A user may access the coupon system 40 (e.g., through an app, a website, and/or a mobile website) through a computer 20 and over a network 30 pursuant to step 160 of the electronic coupon book viewing protocol 150. For instance, a user may be required to enter certain login information, such as specifying a username or account holder 152 (step 162) and/or a password. The associated customized electronic coupon book(s) 82 that have been previously generated and stored on the coupon system 40 may be identified to the user through execution of step 164 (e.g., using the electronic coupon book database 80 (FIG. 5)). If a given user is associated with multiple electronic coupon books 82 within the coupon system 40, the protocol 150 may be configured to allow the user to select a particular one of these electronic coupon books 82.

The electronic coupon book viewing protocol 150 of FIG. 10A could be configured to allow a user to scroll through a corresponding electronic coupon book 82 in any appropriate manner. However, the viewing protocol 150 may also be configured to allow the user to identify particular sponsors 62/coupons 96. For instance, the protocol 150 may be configured to display one or more filter parameters 154 (step 166). The filter parameters 154 allow the user to more expeditiously sort through all of the coupons 96 within a given electronic coupon book 82. The user may select one or more filter parameters 154 pursuant to step 168 of the protocol 150. Coupons 96/sponsors 62 that satisfy the specified filter parameters 154 (step 168) may be displayed to the user pursuant to step 170 of the protocol 150 (e.g., via the user interface 58 of the coupon system 40). One or more of these coupons 96 could be redeemed in the above-noted manner.

One embodiment of a screen that may be presented to a user (e.g., through the user interface 58 of the coupon system 40) for purpose of executing the electronic coupon book viewing protocol 150 of FIG. 10A is illustrated in FIG. 10B. The customized electronic coupon book viewing module 50 of the coupon system 40 (e.g., through the protocol 150) allows the user to perform a filtered search of the coupon book database 80. By selecting one or more filter parameters 154, the search for specific coupons 96 may be simplified from that of manual searching. It should be appreciated that the filter parameters 154 may also be used to expedite the process of generating or compiling electronic coupon books 82 (e.g., by allowing the user to swiftly filter through the regions 72 and the sponsors 62 that the user desires). How the filtered search results are displayed on FIG. 10B may be established/changed by using the sort drop-down menu 101. The filtered search results may be sorted on the screen based upon sort options such as expiration date for coupons 96, location of one or more computers 20 that have been associated with a user in the coupon system 40, sponsors 62, and the like.

A user of the couponing system 10 may have multiple electronic coupon books 82 stored on the coupon system 40. Each fundraising organization 92 that is affiliated with the user in the coupon system 40 (by having an associated electronic coupon book 82) may be listed under a fundraising organization filter 172 in FIG. 10B (e.g., via the user interface 58). One of the filter parameters 154 for the electronic coupon book viewing protocol 150 of FIG. 10A may be this fundraising filter 172. That is, the protocol 150 could be configured to allow the user to select one or more electronic coupon books 82 to search for associated coupons 96 (through selection of one or more fundraising organizations 92 under the fundraising organization filter 172 in FIG. 10B).

Other filter parameters 154 for the electronic coupon book viewing protocol 150 of FIG. 10A are shown in FIG. 10B. An expiration filter 174 enables a user to select a specific time (e.g., day, month, year, etc.) that electronic coupons 96 in the selected electronic coupon book(s) 82 are set to expire. A number of different predetermined expiration windows 142 (expiring coupon notification protocol 140 of FIG. 9) may be set forth in an expiration date drop down window 176, and may be used as a filter parameter 154 in relation to the electronic coupon book viewing protocol 150. A location filter 178 may have a distance drop down window 180 that allows a user to select a proximity value for coupons 96/sponsors 62 within the selected electronic coupon book(s) 82. Any number of predetermined proximity values (e.g., the distance of the user/computer 20 from a given sponsor 62) may be selectable through the distance drop down window 180. Category filter 182 in FIG. 10B gives multiple category options 184 (e.g., clothing, fast food, activities) for coupons 96 that may be contained within the selected electronic coupon book(s) 82. A user of the coupon system 40 may select any one or more of the category options 184. A sponsor filter 190 may list one or more of the sponsors 62 (e.g., Qdoba, Taco Bell, etc.) that may be contained within the selected electronic coupon book(s) 82. A user of the coupon system 40 may select any one or more of the sponsors 62 as a filter parameter 154 for the electronic coupon book viewing protocol 150 of FIG. 10A.

The various representative filter parameters 154 that are shown in FIG. 10B should decrease the time a user spends looking for a specific coupon 96. As the user updates the selection of filter parameters 154 in FIG. 10B, a listing of coupons 96 that satisfy the selected filter parameters 154 may be displayed as well, including information on the coupon 96, the associated sponsor 62, the associated expiration date 94, and any other appropriate information. By selecting a coupon 96 on the screen shown in FIG. 10B, a pop-up window at least generally in accordance with FIG. 7B may be displayed to allow for redemption of that coupon 96. It should be appreciated that filter parameters 154 may also be used in relation to the compilation or generation of electronic coupon books 82 (e.g., FIGS. 6A and 6B).

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method of couponing that defines a customized electronic coupon book, comprising:
communicating with a coupon system over a network and using at least one computer, wherein the coupon system comprises a plurality of coupon sponsors;
identifying a first fundraising organization to said coupon system using said at least one computer;
selecting, as a first filtering criteria, a coupon sponsor region using said at least one computer;
filtering, based on the first filtering criteria, the plurality of coupon sponsors to generate a first list of coupon sponsors, wherein the first list of coupon sponsors includes only one or more coupon sponsors from the plurality of coupon sponsors that have a geographical region within the selected coupon sponsor region;
receiving, by the at least one computer, and from the coupon system via the network, the first list of coupon sponsors;
outputting, for display on at least one computer, the first list of coupon sponsors;
receiving, by the at least one computer, one or more indications of user input selecting a group of one or more coupon sponsors from said first list of coupon sponsors; and
creating a first customized coupon book from said selecting, wherein said first customized coupon book is stored on said coupon system and is accessible by said at least one computer.

2. The method of claim 1, wherein said coupon system comprises one or more of at least one server and a website.

3. The method of claim 1, wherein said network is selected from the group consisting of the Internet, a wireless network, a public network, or any combination thereof.

4. The method of claim 1, wherein said at least one computer is selected from the group consisting of a desktop computer, a laptop computer, a tablet computer, a smart phone, and a personal digital assistant.

5. The method of claim 1, wherein said communicating comprises using one or more of a mobile website and an app stored on said at least one computer.

6. The method of claim 1, wherein each coupon sponsor on said first list is a provider of goods, a provider of services, or both.

7. The method of claim 1, wherein said geographical region in the first filtering criteria is a default region based upon a location of said first fundraising organization.

8. The method of claim 7, wherein said geographical region in the first filtering criteria encompasses a location of said first fundraising organization.

9. The method of claim 7, wherein said geographical region in the first filtering criteria excludes a location of said first fundraising organization.

10. The method of claim 1, wherein said first customized coupon book is associated with said identified first fundraising organization.

11. The method of claim 10, wherein said first fundraising organization is selected from the group consisting of a youth sports organization, a youth activities organization, a non-profit organization, or any combination thereof.

12. The method of claim 1, wherein at least one coupon is available from each coupon sponsor on said first list.

13. The method of claim 1, wherein said one or more indications of user input selecting the group of one or more coupon sponsors comprises one or more indications of user input purchasing at least one coupon for each selected coupon sponsor.

14. The method of claim 1, further comprising:
using said at least one computer to initiate storage of said first customized coupon book.

15. The method of claim 1, wherein said creating comprises assigning an expiration date for each coupon in said first customized coupon book.

16. The method of claim 15, wherein said assigning is based upon a date on which said customized coupon book is created.

17. The method of claim 1, wherein said method further comprises receiving a notification on said at least one computer regarding a second list of coupon sponsors that are outside of said first geographical area, wherein said receiving is executed when said at least one computer is located outside of said first geographical area and when said at least one computer is within a second geographical area associated with said second list of coupon sponsors.

18. The method of claim 17, wherein said notification regarding said second list is issued by said coupon system.

19. The method of claim 17, further comprising:
using said at least one computer to select at least one coupon sponsor from said second list for addition to said first customized coupon book.

20. The method of claim 1, further comprising:
receiving a coupon available notification on said at least one computer that identifies at least one coupon sponsor from said first customized coupon book and that is based upon both a current location of said at least one computer and a location of said at least one coupon sponsor.

21. The method of claim 20, wherein said coupon available notification is issued by said coupon system.

22. The method of claim 20, wherein said coupon available notification is received when said at least one computer is within a predetermined distance of said at least one coupon sponsor.

23. The method of claim 1, further comprising:
receiving an expiring coupon notification on said at least one computer that identifies at least one coupon in said first customized coupon book that is expiring within a predetermined time period.

24. The method of claim 23, wherein said coupon available notification is issued by said coupon system.

25. The method of claim 1, further comprising:
reviewing at least part of said first customized coupon book using said at least one computer.

26. The method of claim 25, wherein said reviewing comprises accessing said coupon system.

27. The method of claim 25, wherein said reviewing comprises using at least one filter.

28. The method of claim 27, wherein said at least one filter comprises an expiration date, location information, goods/services category information, and sponsor information.

29. The method of claim 1, further comprising:
using said at least one computer to associate said first customized coupon book with a first account holder.

30. The method of claim 29, further comprising:
wherein said first customized coupon book is associated with each of said first fundraising organization and said first account holder.

31. The method of claim 30, further comprising:
identifying a second fundraising organization to said coupon system using said at least one computer;
reviewing a second list of coupon sponsors from said coupon system using said at least one computer;
selecting a plurality of coupon sponsors from said second list using said at least one computer;
creating a second customized coupon book from said selecting in relation to said second list; and
associating said customized coupon book with said first account holder.

32. The method of claim 31, further comprising:
identifying one of said first customized coupon book and said second customized coupon book using said at least one computer; and
adding to an identified customized coupon book from said identifying and using said at least one computer.
